(19) United States
(12) Patent Application Publication
(10) Pub. No.: US 2002/0077062 A1
(43) Pub. Date: Jun. 20, 2002

(54) Information service system and operation method thereof

(75) Inventors: Yong Hyun An, Seoul Korea (KR); Yi Sik Chae, Koyang-shi (KR)

Correspondence Address: FLESHNER & KIM, LLP, P.O. Box 221200, Chantilly, VA, 20153-1200, US

(73) Assignee: LG Electronics Inc.

(21) Appl. No.: 10/012,459

(22) Filed: Dec. 12, 2001

(30) Foreign Application Priority Data
Dec. 14, 2000 (KR) 2000/76421

(51) Int. Cl. H04B 5/00

(52) U.S. Cl. 455/41; 455/67.1

(57) ABSTRACT

A shopping center information service system and its operation method are disclosed. The entrance of customers into a shopping center building, such as a department store, is continuously monitored. Information on respective shops in the building and sudden event information generated from the respective shops are provided to a mobile terminal of the customer, while the customer shops within the building. Thus, the customer can do his/her shopping conveniently.

### BACKGROUND OF THE INVENTION

1. Field of the Invention

The present invention relates to an on-line information service system and an operation method and, more particularly, an online information system and method.

2. Background of the Related Art

Generally, a department store or a large-sized discount store comprises a group of shops within a building. Each shop in the department store manages the visit of customers by performing its own event, day after day.

However, information on such an event is provided off-line and only to visiting customers on the floor, where the corresponding shop is located. Thus, the customers who are visiting other shops in the same building cannot be informed of the event.

Specifically, each shop advertises using only printing notices, such as handbills, pamphlets, etc., or using a placard for the advertisement of its own shop, and thus the effect of the advertisement is very insignificant.

Accordingly, the customer is unaware of an event the respective shop may be having, which he/she has not obtained through some other advertising means, when visiting the shopping center. Also, the customer cannot recognize where his/her desired shop is located within the building.

Consequently, the customer must visit the respective shops in the building to locate the desired goods sold by each shop. If the customer does not take pleasure in shopping, he/she has no choice but to ask a shop clerk for sales information or to visit the respective shops in order to purchase a specified good.

As a result, it is urgently required to provide an on-line service system that can properly provide information on various kinds of events, on-going within a specified building that the customer is visiting, or various kinds of information needed by the customer within the building.

### SUMMARY OF THE INVENTION

An object of the invention is to solve at least the above problems and/or disadvantages and to provide at least the advantages described hereinafter.

Accordingly, the present invention is directed to a shopping center information service system and an operation method thereof that substantially obviates one or more problems due to limitations and disadvantages of the related art.

An object of the present invention is to provide a shopping center information service system and an operation method thereof that can provide, through a customer's mobile terminal, information on respective shops within a shopping center or a large-sized shopping center building that the customer is visiting and information on a sudden event generated from a specified shop within the building.

To achieve these objects and other advantages and in accordance with the purpose of the invention, as embodied and broadly described herein, a shopping center information service system includes a database server for receiving and storing information on respective shops, residing in a specified building and a data transmission server installed at each entrance of the building. The data transmission server enables a data transmission/reception with a customer's mobile terminal and transmits the information on the respective shops of the corresponding building, stored in the database server, to the customer's mobile terminal when the customer visits the building.

In another aspect of the present invention, a method of operating an information service system includes continuously confirming a visit of a customer, connecting a data transmission server with a mobile terminal of the customer so as to enable a data transmission/reception between the data transmission server and the mobile terminal, if the visit of the customer is confirmed, and obtaining information on respective shops from a database server and transmitting the obtained information to the corresponding mobile terminal of the customer.

In still another aspect of the present invention, a method of operating an information service system includes continuously confirming an entrance of a customer into a building; obtaining information on a mobile terminal of a specified customer, when the customer visits the inside of the building, and registering the obtained information in a database server; continuously confirming generation of a sudden event from respective shops in the building; and obtaining event information data and transmitting the obtained event information data to the respective mobile terminal of the customer in the corresponding building, if it is confirmed that the sudden event is generated from a specified shop.

In still another aspect of the present invention, a method of operating an information service system includes continuously confirming an entrance of a customer into a specified building, judging whether the customer comes into or goes out of the building if the entrance of the customer is confirmed, and updating a database server with resultant information of the judgement.

The objects of the invention may be achieved in whole or in part by an information server, including a location server that determines whether a subscriber terminal has entered or left a predetermined area; a database server that stores information; and a data transmission server that communicates the stored information to the subscriber terminal when the subscriber terminal is determined to be within the predetermined area.

The objects of the invention may be achieved in whole or in part by An information service method, including determining whether a subscriber terminal has entered or left a predetermined area; storing information in a database server; and communicating the stored information to the subscriber terminal when the subscriber terminal is determined to be within the predetermined area.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the construction of a shopping center information service system according to a preferred embodiment of the present invention;

FIG. 2 is a flowchart illustrating a process of operating the shopping center information service system according to a preferred embodiment of the present invention;

FIG. 3 illustrates the construction of a shopping center information service system according to a second preferred embodiment of the present invention;

FIGS. 4A, 4B are a flowchart illustrating a process of operating the shopping center information service system according to the second preferred embodiment of the present invention; and

FIG. 5 is a flowchart illustrating an operation process performed by a mobile communication network that is used for providing the service, according to a third preferred embodiment of the present invention.

### DETAILED DESCRIPTION OF PREFERRED EMBODIMENTS

Reference will now be made in detail to the preferred embodiments of the present invention, examples of which are illustrated in the accompanying drawings.

According to the preferred embodiments of the present invention, the shopping center information service system and the operation method thereof provide information data of respective shops, residing in a specified building, that a customer is visiting and information on a sudden event, generated in a specified shop in the building, to a mobile terminal of the customer.

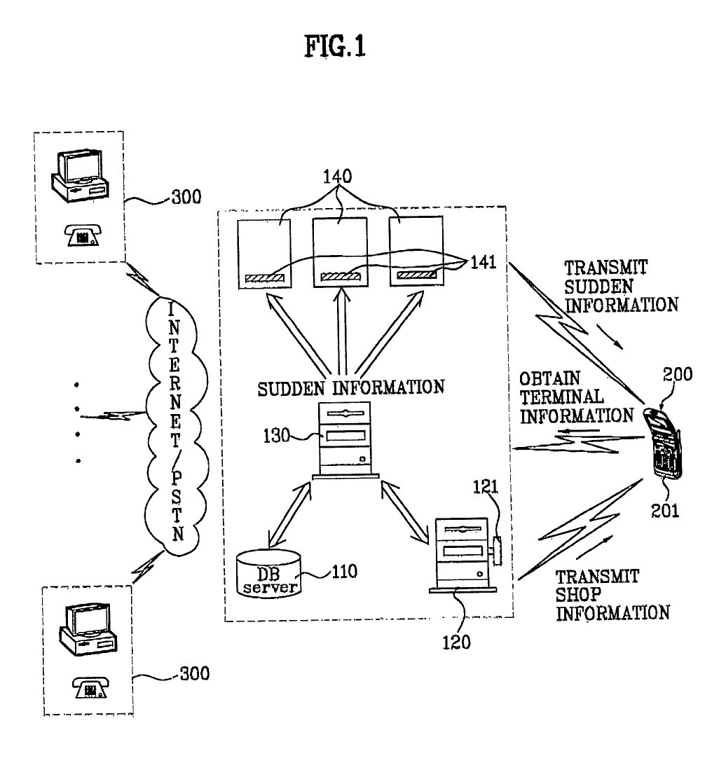

FIG. 1 is a view schematically illustrating the construction of a shopping center information service system according to a preferred embodiment of the present invention. The information service system includes a database server 110 that receives and stores information on the respective shops within a specified building. A data transmission server 120, installed at each entrance of the building, enables a data transmission/reception with a customer's mobile terminal 200 and transmits the information stored in the database server 110 to the customer's mobile terminal 200 when the customer visits the building. An operation server 130 controls the database server 110 and the data transmission server 120. The database server 110 is connected with networks (for example, personal computers, mobile terminals, wired telephones, etc.) installed in the respective shops and is constructed to continuously receive the information on the respective shops.

The information service system may further comprise at least one sudden information data transmission section 140 installed inside respective parts of the building. The sudden information data transmission section 140 is connected to the operation server. If a sudden event is generated from a shop, the data transmission section 140 transmits the event information to the mobile terminal 200 of the customer who is visiting the building. The sudden information data transmission section 140 is installed within a range where a short-distance radio transmission to the customer's terminal 200 is possible.

Also, radio data transmitters/receivers 121, 141, and 201 are installed in the data transmission server 120, the sudden information data transmission section 140, and the mobile terminal 200 of the customer, respectively, so that the radio data transmission/reception is possible among the devices. The radio data transmitter/receiver 121,141, or 201 may preferably be a transceiver chip, using the typical Bluetooth technique, or an appliance for an infrared (IR) data communication, etc. The radio data transmitter/receiver may also be a serial port for a radio or wired data transmission.

The data transmission server 120 installed at the entrance of the building should confirm the identity of the corresponding customer, by recognizing the approach of the radio data transmitter/receiver 201 installed in the customer's mobile terminal 200. This can be achieved using typical software that mutually confirms the radio data transmitters/receivers for the data transmission between the data transmission server and the mobile terminal, and thus the detailed explanation thereof will be omitted.

Hereinafter, the service method using the information service system constructed as above will be explained.

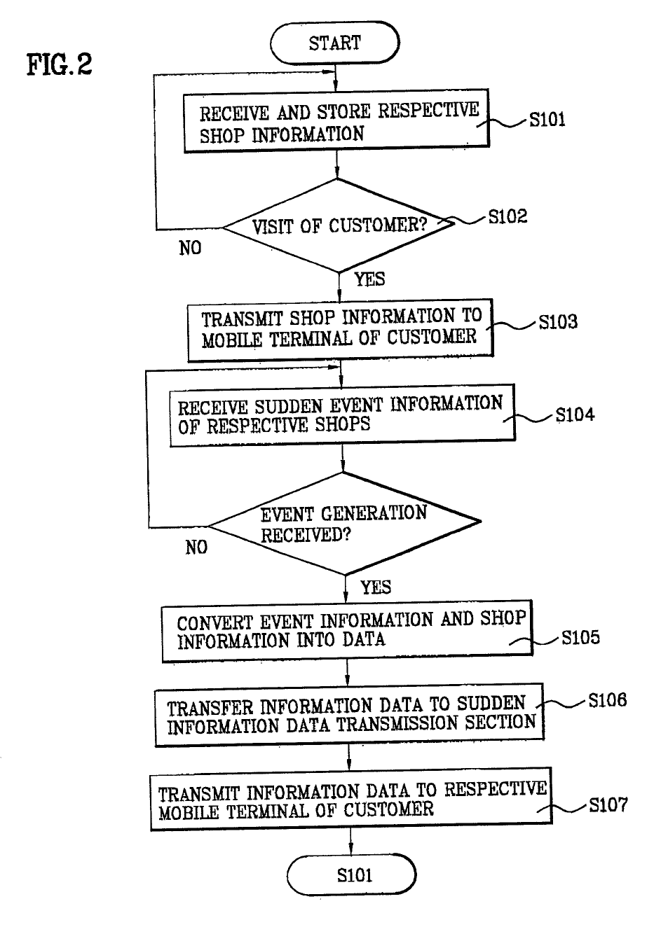

Referring now to FIGS. 1 and 2, the operation server 130 that is installed in a building (for example, a department store building), in which there are a plurality of shops, continuously receives the information on the respective shops from the networks 300 of the corresponding shops and stores the received information in the database server 110 (step S101). Then, the operation server 130 continuously confirms the visit of a customer through the data transmission server 120, which is installed in one or more entry ways of the building (step S102). This can be effected through the customer's manipulation of the data transmission server 120 or his/her own mobile terminal 200, to request the transmission of the information data.

In this visit confirmation state, the operation server 130 transmits to the customer's mobile terminal 200 the information on the shops within the shopping center building, through the radio data transmitter/receiver 121 of the data transmission server 120 (step S103). To accomplish this, the data transmission server 120 communicates with the database server 110, obtains the information on the respective shops stored in the database server 110, and transmits the obtained information to the customer's mobile terminal 200.

Alternatively, the data transmission server 120 is continuously connected to the database server 110, waiting for the transmission of the information. If the customer visits the building, the data transmission server 120 transmits the information.

The information on the shops may include the goods sold by the corresponding shop, prices of the respective goods, daily event plans, current events, location of the shops, etc. Preferably, the information on the location of the shops is provided as a guide, so that the customer can find the corresponding shop more easily.

Accordingly, the customer can obtain information on the respective shops within the building through his/her own mobile terminal 200 and, thus, can enjoy his/her shopping by easily obtaining the necessary information during the shopping. That is, the customer can easily find the corresponding shop having goods that the customer desires to purchase, the location of the shop, event information on the respective shops (for example, terms of discount selling and so on), etc., through his/her own mobile terminal 200.

Meanwhile, during the above-described process, the operation server 120 continuously receives updated event information from the networks 300 of the respective shops (step S104). If a certain shop intends to perform a sudden event (for example, a short-term discount selling or issuance of discount tickets to many and unspecified persons) and transfers such event information to the operation server 130 through the network 300, installed in the corresponding shop, the operation server 130 converts the contents of the transferred event into data (step S105). Thereafter, the operation server 130 transfers the data to the data transmission server 120 and the sudden information data transmission section 140 (step S106), while simultaneously storing the data in the database server 110.

The sudden information data transmission section 140 transmits the radio data of the event information to many and unspecified persons (step S107). The data is transmitted only to the customer's mobile terminal 200 located within an allowable data transmission range of the sudden information data transmission section 140.

Preferably, at least one sudden information data transmission section 140 is installed on every floor or specified position of the inside of the building. Thus, a simultaneous data transmission is possible with respect to all the customers' mobile terminals 200 located inside the building. Any customer going into the building can receive the information of the respective shops, with the updated sudden event generation information, through the data transmission server 120.

There are various methods of confirming the event information, inputted from the network installed in a specified shop, and transferring the event information to the sudden information data transmission section 140, during the above-described process. In the present invention, two methods are preferred.

According to one preferred method, the times for inputting the typical shop information are predetermined. Any information inputted at some time other than the predetermined times is judged to be event information, rather than typical shop information.

According to the other preferred method, a person in charge of the respective shop selects the type of information when inputting it to the database server 110, so that it is identified as either event or basic information of the shop.

As a result, the customer can recognize the generation of the sudden event in real time, through his/her own mobile terminal 200, and thus can be satisfied with his/her shopping.

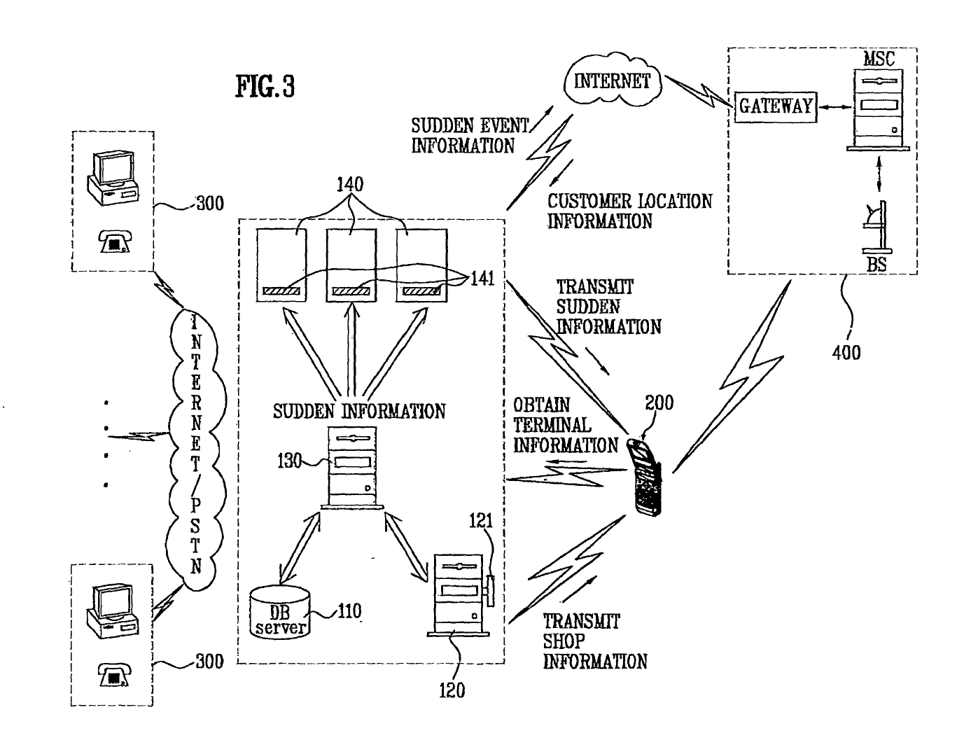

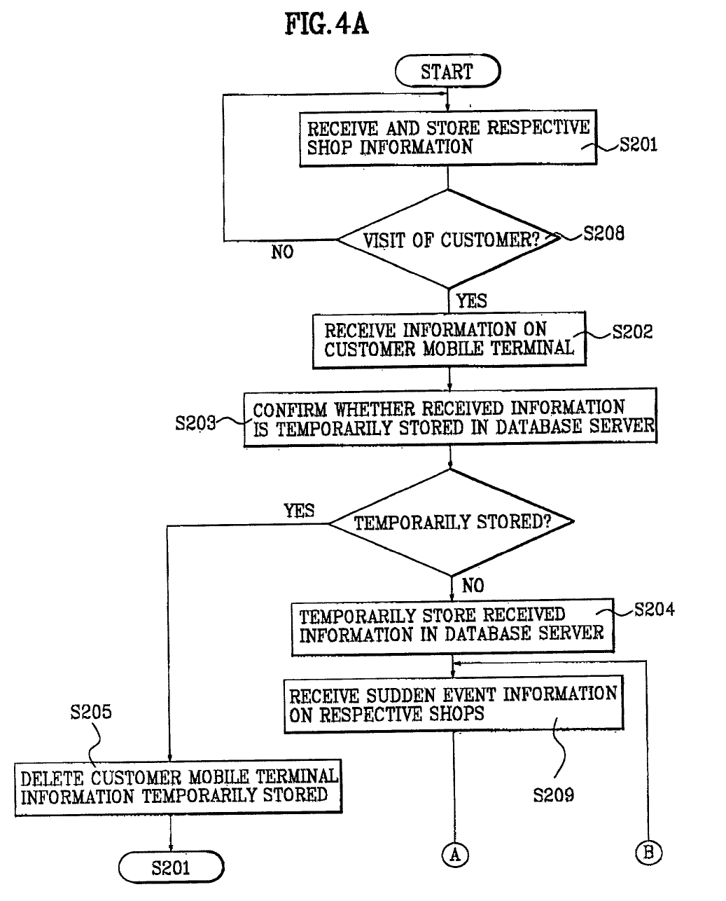

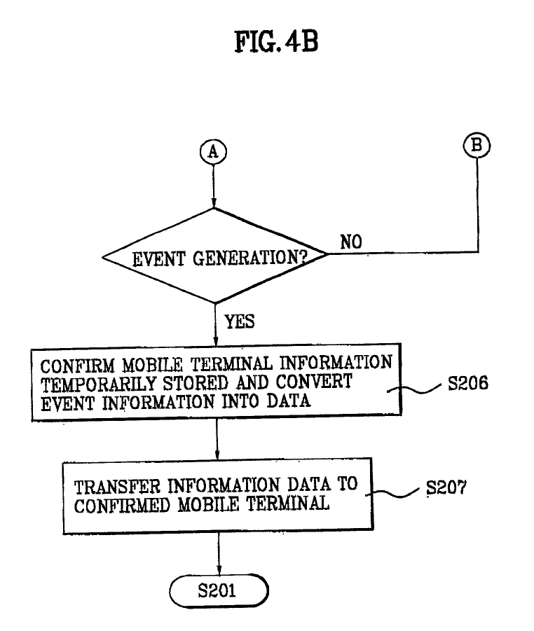

The method of operating the information service system according to a second preferred embodiment of the present invention provides the sudden event generation information to the customer's mobile terminal 200 through a mobile communication network 400, without installing a plurality of sudden information data transmission sections 140 within the building. For this, as shown in FIG. 3, the operation server 130 is connected to the mobile communication network 400, in addition to the construction described above. The method of operating the information service system according to the second preferred embodiment of the present invention will be explained with reference to FIG. 4A, 4B.

The operation server 130 stores information from the respective shops as it is received (step S201). Additionally, the operation server 130 continuously identifies the entrance of a customer, through the data transmission server 120, and temporarily stores the customer state information (step S208). The reason why the customer state information is temporarily stored is to provide the customer the event information, generated in a specified shop in the building, when the customer is in the corresponding building and to stop providing information when the customer goes out of the building, after finishing his/her shopping.

Preferably, when the customer passes through the gateway of the building, the customer's entrance is determined by receiving information from the customer's mobile terminal 200 (step S202). Then, the operation server 130 confirms whether the information received from the mobile terminal 200 is temporarily stored (step S203). If the entrance of the customer is determined, the operation server 130 enters a state that allows various kinds of information to be provided, while if the customer goes out of the building, it stops providing the information.

That is, if the information on the mobile terminal 200 of a customer passing through the gateway is not temporarily stored in the database server 110, the operation server 130 judges that the customer is coming into the building and temporarily stores the mobile terminal 200 information of the corresponding customer in the database server 110 (step S204). If the information on the mobile terminal 200 of a customer passing through the gateway is already stored in the database server 110, the operation server judges that the customer is going out of the building, after finishing his/her shopping, and deletes the mobile terminal 200 information of the corresponding customer stored in the database server 110 (step S205).

During the above-described process, if a sudden event is generated from a specified shop in the building, the operation server 130 obtains the event information (step S209), identifies the registered mobile terminals 200 of the visiting customers (step S206), and transmits the event information to the registered mobile terminals 200 of the visiting customers through the mobile communication network 400 (step S207). The transmission of the information is preferably performed using a short message service (SMS), provided by the mobile communication network.

Accordingly, the customer can easily obtain the event information on the respective shops, generated within the building.

The above-described confirmation of the customer's entrance to the building is not limited to the data transmission server 120. For example, a mobile communication technique can accurately confirm the location of the customer. The operation server 130 may be connected to the mobile communication network 400 (especially, a Base Station or a Mobile Switching Center) to confirm the customer's entrance to the corresponding building. In this case, the operation server 130 can confirm the entrance of the corresponding customer based on the customer's position information provided by the mobile communication network 400.

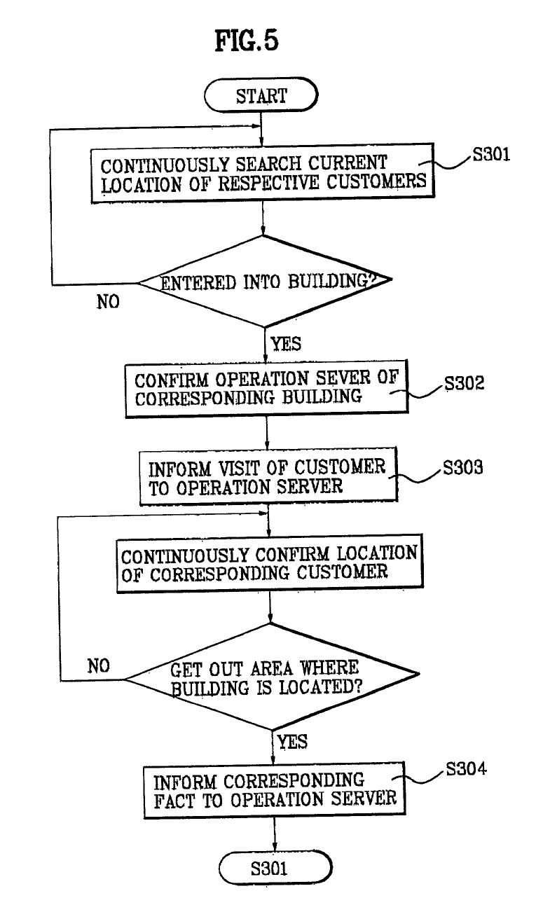

As shown in FIG. 5, the mobile communication network 400 continuously receives a pilot signal originated from the respective customer's mobile terminal 200 and identifies the location of the corresponding customer (step S301). In this process, if the customer stays in an area where a specified building, such as a department store, is located for a long time, the mobile communication network 400 identifies the operation server 130, installed in the corresponding building (step S302), and informs the operation server 130 of information regarding the customer's visit (step S303). If the visiting customer moves and gets out of the building, the mobile communication network 400 so informs the operation server 130 (step S304), so that the operation server 130 knows of the customer's entrance and exit.

The information regarding a customer's visit may include the customer's mobile terminal 200 phone number and an Internet protocol (IP) for data transmission/reception.

The sudden event information is not limited to an event generated by the shops, but may be an announcement forwarded by the management of the corresponding building. For example, the announcement could be a state of emergency message, regarding a fire, calamity, etc.

As described above, shop information inside the building that the customer is visiting and sudden event information generated from the respective shops are instantly provided to the mobile terminal of the customer. Thus, the customer can do his/her shopping with improved satisfaction.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An information service system, comprising:
a database server that receives and stores information on entities within a predetermined area;
a data transmission server at a prescribed location that communicates with a customer's mobile terminal and communicates the information on the entities to the customer's mobile terminal, when the customer is within the predetermined area; and
an operation server that controls the database server and the data transmission server.

2. The system of claim 1, wherein a radio data transmitter/receiver is installed in the data transmission server and the customer's mobile terminal, respectively, for a mutual radio data transmission/reception.

3. The system of claim 1, further comprising a sudden information data transmission device, installed within the predetermined area, that radio-transmits event information when a sudden event is generated by one of the entities.

4. The system of claim 3, wherein the sudden information data transmission device communicates by a short-distance radio transmission.

5. The system of claim 3, wherein a radio data transmitter/receiver is installed in the sudden information data transmission device to support the radio transmission.

6. The system of claim 1, wherein the prescribed location is within the predetermined area.

7. The system of claim 6, wherein the predetermined area is a building.

8. The system of claim 6, wherein the predetermined area is a building and the vicinity of the building.

9. The system of claim 1, wherein the data transmission server communicates directly with the customer's mobile terminal.

10. The system of claim 1, wherein the data transmission server communicates indirectly with the customer's mobile terminal.

11. The system of claim 10, wherein the data transmission server communicates with the customer's mobile terminal through a third-party wireless communication gateway.

12. A method of operating an information service system, comprising:
determining whether a potential customer is within a prescribed area;
obtaining information of a vendor from a database server; and
transmitting the information between a data transmission server and a customer's mobile terminal if the potential customer is within the prescribed area.

13. The method of claim 12, wherein the data transmission server transmits the information to the mobile terminal by a wired or a radio medium.

14. The method of claim 12, further comprising receiving customer information, regarding the mobile terminal, with the data transmission server while transmitting the vendor information to the mobile terminal.

15. The method of claim 14, wherein the customer information comprises at least one of a phone number of the mobile terminal and an Internet Protocol (IP) used by the mobile terminal.

16. The method of claim 12, further comprising:
receiving event information from a network of a specified vendor, if a sudden event is generated by the specified vendor; and
registering the received event information in the database server and radio-transmitting the event information to the customer's mobile terminal, located within a range where reception by the mobile terminal is possible, by controlling a respective sudden information data transmission section.

17. The method of claim 12, wherein the prescribed area is a building.

18. The method of claim 12, wherein the prescribed area is a building and the vicinity of the building.

19. The method of claim 12, wherein the data transmission server communicates directly with the customer's mobile terminal.

20. The method of claim 12, wherein the data transmission server communicates indirectly with the customer's mobile terminal.

21. The method of claim 20, wherein the data transmission server communicates with the customer's mobile terminal through a third-party wireless communication gateway.

22. A method of operating an information service system, comprising:
confirming an entry of a customer into a building;
obtaining information regarding a mobile terminal of the customer, when the customer visits the building, and registering the obtained information in a database server;
awaiting a sudden event from a vendor in the building; and
obtaining event information and transmitting the obtained event information to the customer's mobile terminal, in the building, when the sudden event arrives from the vendor.

23. The method of claim 22, wherein the event information is radio-transmitted to the customer's mobile terminal, located within a range where reception by the mobile terminal is possible, by controlling a respective sudden information data transmission section installed within the building.

24. A method of operating an information system, comprising:
confirming a passage of a customer through an entry way of a building;
judging whether the customer enters or leaves the building, if the passage of the customer is confirmed; and
updating a database server with resultant information of the judgement.

25. The method as claimed in claim 24, wherein judging whether the customer enters or leaves the building comprises:
obtaining customer information regarding a mobile terminal of the customer;
determining whether the customer information is stored in the database server;
judging that the customer is entering the building and temporarily storing the customer information in the database server, if the customer information is not stored in the database server; and
judging that the customer is leaving the building and deleting the stored customer information, if the customer information is stored in the database server.

26. The method of claim 24, wherein the judgment of whether the customer enters or leaves the building is based on information regarding a mobile terminal of the customer received from a mobile communication network that can identify a location of the mobile terminal.

27. The method of claim 26, further comprising:
temporarily registering the information regarding the mobile terminal in the database server, if the information received from the mobile communication network indicates that the corresponding mobile terminal has come into the building; and
deleting the information regarding the mobile terminal temporarily stored in the database server, if the information received from the mobile communication network indicates that the corresponding mobile terminal has left the building.

28. An information server, comprising:
a location server that determines whether a subscriber terminal has entered or left a predetermined area;
a database server that stores information; and
a data transmission server that communicates the stored information to the subscriber terminal when the subscriber terminal is determined to be within the predetermined area.

29. The information server of claim 28, wherein:
the data transmission server communicates with the subscriber terminal when the subscriber terminal comes within communication range of the data transmission server;
the location server registers identification information received from the subscriber terminal in the database server, if the subscriber terminal is not currently registered;
the location server determines that the subscriber terminal has entered the predetermined area, if the subscriber terminal is not currently registered when the location server receives the identification information; and
the location server determines that the subscriber terminal has left the predetermined area, if the subscriber terminal is currently registered when the location server receives the identification information.

30. The information server of claim 28, wherein:
the location server receives identification information of the subscriber terminal from a network server, if the network server detects that the subscriber terminal is located near the predetermined area for a predetermined period of time;
the location server receives subsequent identification information of the subscriber terminal from the network server, if the network server detects that the subscriber terminal has left the predetermined area after being located within the predetermined area for the predetermined period of time; and
the location server determines whether the subscriber terminal has entered or left the predetermined area based on the identification information and the subsequent identification information.

31. An information service method, comprising:
determining whether a subscriber terminal has entered or left a predetermined area;
storing information in a database server; and
communicating the stored information to the subscriber terminal when the subscriber terminal is determined to be within the predetermined area.

32. The method of claim 31, further comprising:
communicating with the subscriber terminal when the subscriber terminal comes within communication range of a data transmission server;
registering identification information received from the subscriber terminal in the database server, if the subscriber terminal is not currently registered;
determining that the subscriber terminal has entered the predetermined area, if the subscriber terminal is not currently registered when the location server receives the identification information; and
determining that the subscriber terminal has left the predetermined area, if the subscriber terminal is currently registered when the location server receives the identification information.

33. The method of claim 31, wherein:
receiving identification information of the subscriber terminal from a network server, if the network server detects that the subscriber terminal is located near the predetermined area for a predetermined period of time;
receiving subsequent identification information of the subscriber terminal from the network server, if the network server detects that the subscriber terminal has left the predetermined area after being located within the predetermined area for the predetermined period of time; and
determining whether the subscriber terminal has entered or left the predetermined area based on the identification information and the subsequent identification information.

34. The method of claim 31, wherein the information stored in the database is obtained from vendors within the predetermined area.
